(19) United States
(12) Patent Application Publication
(10) Pub. No.: US 2018/0146019 A1
(43) Pub. Date: May 24, 2018

(54) LIGHT-WEIGHT RESOLUTION SWITCHING FOR ONLINE VIDEO STREAMING

(71) Applicant: INTERNATIONAL BUSINESS MACHINES CORPORATION, Armonk, NY (US)

(72) Inventors: Hsiang-Wen Chen, Keelung City (TW); Hsiao-Yung Chen, New Taipei City (TW); Wen-Ping Chi, New Taipei City (TW); Hsin Yu Hsieh, Taipei City (TW); Wendy Ping Wen Wang, Taipei (TW)

(21) Appl. No.: 15/357,388

(22) Filed: Nov. 21, 2016

(51) Int. Cl. H04L 29/06; H04L 12/26

(52) U.S. Cl. CPC H04L 65/602; H04L 65/4069; H04L 67/02; H04L 43/0882; H04L 65/80

(57) ABSTRACT

A method of providing high resolution video content with reduced latency, including, determining available bandwidth of a communication path, and sending delta-value video content segments to a client device if the available bandwidth is above a first threshold value.

### BACKGROUND

### Technical Field

The present invention generally relates to improved switching between low resolution (LR) video and high resolution (HR) video using Dynamic Adaptive Streaming over HTTP (DASH), and more particularly to using delta values in place of stored high resolution video segments to increase high quality, low-resolution streaming video to high quality, high-resolution streaming video in real-time.

### Description of the Related Art

People viewing multi-media content like shows and movies on their remote devices would like to receive higher quality, lower latency video to improve their viewing experience. Multi-media content providers may be judged by their audience based on their ability to provide such viewing experiences.

Presently multi-media content service providers (CSP) (e.g., YouTube, NetFlix, etc.) may transmit multi-media content over a packet-switched network (e.g., the Internet, Wide Area Networks (WANs), Metropolitan Area Networks (MANs), Local Area Networks (LANs), etc.) to a client device using a server-push approach, where a server continuously sends data packets to the receiver using a communication protocol (e.g., User Datagram Protocol/Transmission Control Protocol (UDP/TCP), Real-time Transport Protocol (RTP)/RTP Control Protocol (RTCP)), or a client-pull approach, where the receiver requests data packets from a server using a communication protocol (e.g., Hypertext Transfer Protocol (HTTP)), for example, over TCP/IP connections.

Multi-media streaming the with MPEG-2 transport stream (TS) also has been used to send media to clients.

The multi-media content may be distributed through a network using the communication protocols of the Internet protocol suite, where the multi-media content may be transmitted as datagrams. By streaming the multi-media content, the client media player can begin to play the multi-media content before an entire data file has been received. A sending node can typically transmit a sequence of datagrams, and the receiving node can typically receive and be able to play back the sequence of datagrams as multi-media content, where the multi-media content can include audio, video, and text (e.g., subtitles) components.

The source content (e.g., audio, video, etc.) can typically be encoded at multiple bit rates for Dynamic Adaptive Streaming over HTTP. The multi-media content may be broken down into discrete time segments of a fixed length having a predetermined file size for low resolution, medium resolution, and high resolution transmissions.

### SUMMARY

In accordance with an embodiment of the present invention, a method of providing high resolution video content with reduced latency is provided. The method includes determining available bandwidth of a communication path, and sending delta-value video content segments to a client device if the available bandwidth is above a first threshold value.

In accordance with another embodiment of the present invention, a method of providing high resolution video content to a client device with reduced latency is provided. The method includes generating delta-value video content segments from low resolution video content segments and high resolution video content segments. The method further includes receiving a Hypertext Transfer Protocol (HTTP) request for a multi-media article from a client device. The method further includes determining available bandwidth of a communication path to the client device. The method further includes sending low resolution video content segments to the client device if the available bandwidth is below a first threshold value, and sending delta-value video content segments to a client device if the available bandwidth is above the first threshold value.

In yet another embodiment, a multi-media content delivery system is provided. The multi-media content delivery system includes a computer system coupled to a memory and having a network interface, wherein the computer system is configured to store one or more low resolution video content segments and one or more delta-value video content segments in the memory, and wherein the computer system is further configured to determine the available bandwidth to a client device of a communication path coupled to the network interface, and send at least one of the one or more delta-value video content segments to the client device in response to a Hypertext Transfer Protocol (HTTP) request.

These and other features and advantages will become apparent from the following detailed description of illustrative embodiments thereof, which is to be read in connection with the accompanying drawings.

### BRIEF DESCRIPTION OF THE DRAWINGS

The disclosure will provide details in the following description of preferred embodiments with reference to the following figures wherein:

FIG. 1 is a diagram of low resolution data sets, delta-value data sets, and high resolution data sets, for streaming multi-media, in accordance with an embodiment of the present invention;

FIG. 2 is a diagram of a multi-media content delivery system including a multi-media content server in communication with various client devices over communication paths including a network, in accordance with an embodiment of the present invention;

FIG. 3 is a diagram of a relationship between low resolution data (e.g., color model values), high resolution data, (e.g., color model values), and A-value data for a video data set using an RGB color model, in accordance with an embodiment of the present invention;

FIG. 4 shows a representation of 8 bits used to store and send a set of color values between 0 and 255 for RGB color model data for each pixel, and the 5 bits used to store and send the A-values for each color of each pixel, in accordance with an embodiment of the present invention;

FIG. 5 shows a representation of available band width varying with time as a dashed line, and data packets of various size utilizing the available bandwidth, in accordance with an embodiment of the present invention;

FIG. 6 is a diagram of the data segments for low resolution content segments and A-value data segments stored in the memory coupled to a multi-media content server (i.e., computer system), in accordance with an embodiment of the present invention;

FIG. 7 is a block diagram of a sequence of low resolution and delta-value video content segments for transmission over a communication path, in accordance with an embodiment of the present invention;

FIG. 8 is a block/flow diagram of a method to prepare video content segments from multi-media articles, in accordance with an embodiment of the invention;

FIG. 9 is a block/flow diagram of a method for calculating Δ-values to generate delta-value video content segment(s), in accordance with an embodiment of the present invention;

FIG. 10 is a block/flow diagram of a method for communicating video content segments for multi-media articles to client devices by DASH, in accordance with an embodiment of the present invention; and

FIG. 11 is a block diagram of an exemplary processing system, which may be included in a computer system and/or client device, in accordance with an embodiment of the present invention.

### DETAILED DESCRIPTION

Principles and embodiments of the present invention relate generally to composing a low resolution data set based on a low resolution multi-media (e.g., audio/video) file and a delta value data set based on the difference between the color model values of the low resolution multi-media file and the color values of a high resolution multi-media file to improve media streaming efficiency and user switching speed.

Principles and embodiments of the present invention also relates generally to a method of communicating sufficient information to reconstruct high-quality, high resolution multi-media content by communicating datagrams containing less than the full color value data set for a high resolution content segment of the multi-media content. A content segment can be a time-ordered sequence of video frames having a predetermined resolution (e.g., high, ultra-high, medium, low, etc.), where the resolution can be measured in N pixels in height by M pixels in width, with each pixel including a set of color model values (e.g., Red-Green-Blue (RGB), YUV/YCbCr, etc.). A full data set (i.e., all the information in a video frame) for a content segment of the multi-media article (e.g., shows, movies, concerts, sporting events, MPEG file, etc.) can include twenty-four bits per pixel (BPP), e.g., 8-bits per color for three colors or luma-chrominance components, multiplied by the number of rows and columns of pixels to generate each video frame, which can be multiplied by the number of video frames per second for the number of seconds in the predetermined time segment of video content. The video component of the multi-media content can be, for example, 24 to 48 frames per second (frames/s).

In various embodiments of the present invention, a data set containing the difference, A-values, between the color model values forming the low resolution (LR) data set and the color model values forming the high resolution (HR) data set can be generated, where the A-values occupy less memory per pixel than the color model values forming the high resolution data set or the low resolution data set. For example, a pixel generated using 8 bits per color for an RGB color space would utilize 24 BPP, whereas the A-values for generating a delta-value data set from the low resolution data set and high resolution data set may involve 5 bits per color including 4 bits for the color Δ-value and a sign bit (positive or negative difference) for a total of 15 BPP instead of 24 BPP. By reducing the bits per pixel for each frame of video, a smaller frame buffer may be used, or more frames may be buffered with the same amount of memory.

A low resolution image and associated low resolution data set can be in the range of about 352 by 240 pixels to about 700 by 480 pixels. A medium resolution image can be in the range of about 700 by 480 pixels to about 1080 by 720 pixels. A high resolution image can be in the range of about 1080 by 720 pixels to about 15360 by 8640 pixels, although other higher resolutions are contemplated. A resolution equal to or greater than 2048 pixels by 1536 pixels can be considered ultra-high resolution.

Principles and embodiments of the present invention also relate to providing a high quality, low resolution image by leveraging current video processing techniques (e.g., blur, chroma-subsampling, etc.) in relation with the image interpretive characteristics of human vision and the eye to provide a lossy compression that can produce a low resolution image with greater clarity and crispness than previous methods of compression, while also providing the ability to increase the transmitted video content to high quality, high resolution images on demand. Lossless video compression technique have been found to have limitations, such as having to use the same algorithm for both compression and decompression, thereby limiting available options.

Exemplary applications/uses to which the present principles can be applied include, but are not limited to: communicating multi-media content to a client device, for example, sending data packets via Dynamic Adaptive Streaming over HTTP (DASH). DASH utilizes HTTP based streaming to provide media segments hosted on a HTTP server, where a client controls a streaming session, for example, using HTTP GET or partial GET requests. A client can open one or more TCP sessions to one or more HTTP servers. The client can choose a delivery rate to match available bandwidth, and change the delivery rate to match available bandwidth during a session. A media segment can be uniquely referenced by an HTTP unique uniform resource locator (URL).

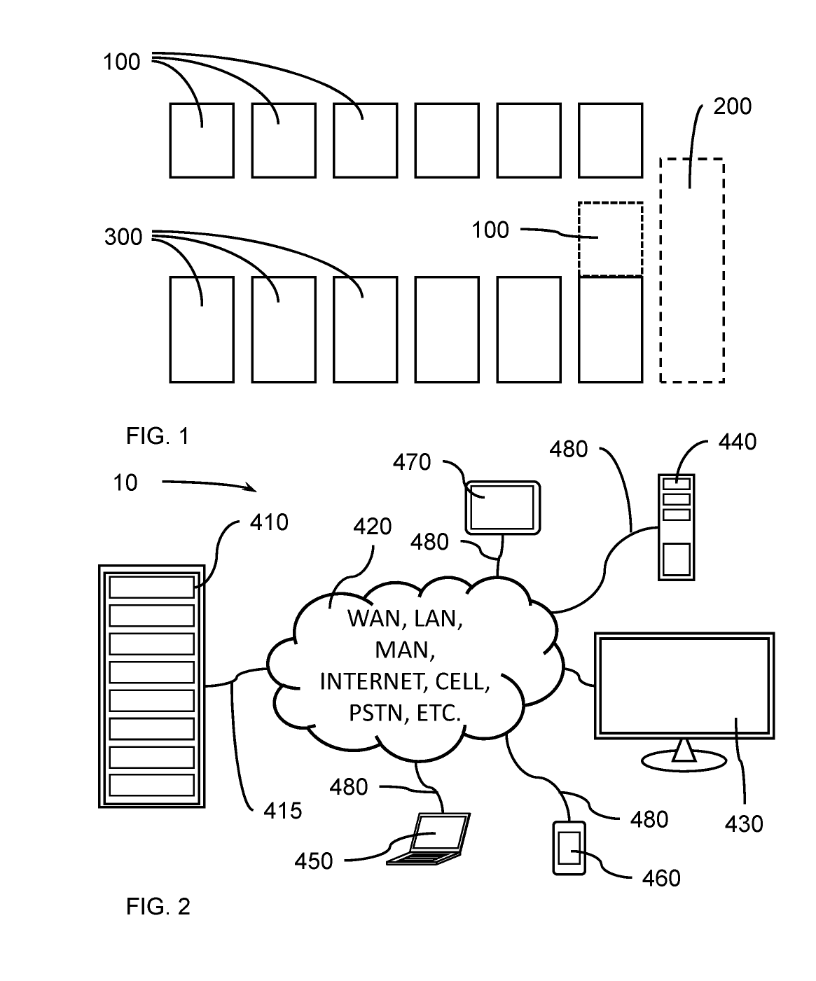

Referring now to the drawings in which like numerals represent the same or similar elements and initially to FIG. 1, a diagram of low resolution data sets, delta-value data sets, and high resolution data sets, for streaming multi-media is shown, in accordance with the present principles.

As the terms are used herein, ‘high’ and ‘low’ can describe the resolution relationship between two or more segments of video content or a complete multi-media article, where resolution refers to the amount of data forming a video frame (e.g., number of distinct pixels in each dimension). The multi-media article can include a raw video file (i.e., before conversion to an industry image format, for example, JPEG or 4:2:2 files).

The digital video content of a multi-media article can be prepared in multiple resolutions utilizing different color models in order to provide a spectrum of qualities from reduced amounts of storage and bandwidth requirements to maximum display resolution. Lower resolution video content can be transmitted over lower bandwidth channels and can require less buffering, so can suffer from fewer pauses, less flicker, less jitter, and less pixilation/macroblocking, etc. High resolution video content puts greater demands on the quality of service (QoS) and bandwidth of the communication channel used, but can provide improved resolution including visual details and picture sharpness. Streaming of digital multi-media content, therefore, involves balancing the tradeoff between resolution and smooth reception and display quality, switching between a high resolution format when bandwidth is available to a low resolution format when bandwidth becomes restricted provides a dynamic adjustment that maximizes overall video quality and viewing experiences for the available bandwidth.

A low resolution format may require a certain amount of storage for a predetermined time segment of video content (e.g., 5 second segments, 8 second segments, 10 second segments, etc.), whereas a high resolution format may require four, eight, or even sixteen times (4×, 8×, 16×, etc.) as much storage and bandwidth for the same multi-media article (e.g., show episode, movie, MPEG file, etc.) and same time segment.

A complete sequence of video content time segments can be prepared at different resolutions for the same multi-media article, where there can be a complete sequence of low resolution (e.g. 1/16^{th} the original video resolution of the multi-media article) video content segments 100, a sequence of medium resolution (e.g. ¼^{th} the original video resolution) video content segments, and a sequence of high resolution (e.g. 1:1 for the original video resolution) video content segments 200. The video content segments can be configured for a particular bit rate, frame rate, and/or frame size. Each of the different resolution video content segments, however, would need to be stored by a content distributor, which takes up excessive storage, since effectively three different copies of the same multi-media article would be stored. The different resolution video content segments can be stored as a file that can be identified by a unique uniform resource locator (URL), and a server could send the video content segments to a client device in response to an HTTP request (e.g., GET request, partial GET request). The video content segment can be the largest unit of data requested by a client.

In one or more embodiments, a delta-value video content segment 300 can be prepared for each video content segment from the low resolution sequence of video content segments 100 and high resolution sequence of video content segments 200, where the delta-value video content segment 300 includes the difference between the pixel color values of the low resolution video content segments 100 and high resolution video content segments 200. The high resolution multi-media content, therefore, can be composed of the low resolution sequence of video content segments 100 plus the delta-value video content segments 300, which requires less memory and bandwidth compared to the high resolution video content segments 200.

Converting the high resolution video content segments 200 into delta-value video content segments 300, therefore, acts as a form of compression. Since the delta-value video content segments include the difference in values, less digital space is needed for each segment than would be required for the complete (e.g., original) values. The delta-value video content segments 300 can also be compressed using various video compression algorithm/codec (e.g., MPEG, MPEG-2, H.264, AV1, VP9, WebM, 3GPP, FLV, SVI, etc.) and stored in the compressed format. The size of the blocks depicted in FIG. 1 suggest the different amounts of memory and bandwidth usage for low resolution video content segments (LRCS) 100, high resolution video content segments (HRCS) 200, and delta-value video content segments (ΔVCS) 300, where high resolution video content segments (HRCS) 200 utilizes the greatest amount of memory and bandwidth usage (LRCS<ΔVCS<LRCS+ΔVCS<HRCS).

FIG. 2 is a diagram of a multi-media content delivery system including a multi-media content server in communication with various client devices over communication paths including a network, in accordance with an embodiment of the present invention.

In one or more embodiments, multi-media content can be delivered over a multi-media content delivery system 10 (e.g., content delivery network (CDN)). In one or more embodiments, multi-media content can be stored on a computer system 410 (e.g., server) connected to a packet-switched network 420, where the computer system 410 can send data packets over the communication path 415 to one or more client devices, which can include but not be limited to, for example, smart televisions 430, desktop personal computers 440, laptop computers 450, smart phones 460, and tablets 470. The computer system 410 can run web server software (e.g., Apache HTTP Server™, IBM® HTTP Server, etc.) and/or database software, and the computer system 410 can be an original content server or a proxy server (e.g., proxy cache infrastructure). The client devices can be media players configured to receive multi-media content and present the multi-media content to a user on a display. Each client device can be connected to the packet-switched network over a separate communication path 480.

In various embodiments, video content segments may be stored as files on a web server capable of transmission as packets over multi-media content delivery system 10, and sent to the client devices using Hypertext Transfer Protocol (HTTP) in response to requests (e.g., HTTP GET request) from, for example, a web browser or suitably configured application software. The computer system can be configured to send one or more delta-value video content segments as packets in response to a GET request or partial GET request. The client/user, thereby, primarily controls the streaming of the video content segments by issuing a GET request or partial GET request.

The communication path may be wired (e.g., public switched telephone network (PSTN), cable, fiber optic line, etc.) or wireless (e.g., radio, microwave, WiFi, WiMAX, cellular network, infra-red (IR), etc.), and satellite communication may be employed. The packet-switched network 420 and communication path(s) 415, 480 can form a content delivery network to distribute the multi-media content from a multi-media content provider to multiple users. The communication path(s) 415, 480 can be two-way communication paths, where a client device 430, 440, 450, 460, 470 can send a request to a computer system 410, and the computer system can send a response to the client device.

The communication path(s) 415, 480, and packet-switched network 420 can have a bandwidth that indicates and limits the data volume that can be communicated from the content provider's computer system 410 to the client device 430, 440, 450, 460, 470 at a given time. The available bandwidth can determine how much data can be communicated from the computer system 410 (also referred to as a sending node) to the client device 430, 440, 450, 460, 470, (also referred to as a receiving node), and whether the user will receive a high resolution version or low resolution version of a requested multi-media article. Since the low resolution sequence of video content segments 100 plus the delta-value video content segments 300 requires less bandwidth than the high resolution video content segments 200, a user can receive a high resolution version of the multi-media article at a lower threshold bandwidth than if the full high resolution video content segments 200 of the multi-media article were being sent. If the available bandwidth is below the threshold bandwidth for communicating the low resolution sequence of video content segments 100 plus the delta-value video content segments 300, the low resolution video content segments could still be sent and received by the client device. When the available bandwidth improves, such that the bandwidth is at or above the threshold, the client can again be sent the high resolution multi-media content in the form of the low resolution sequence of video content segments 100 plus the delta-value video content segments 300. The content provider's computer system 410 can switch from sending the low resolution sequence of video content segments 100 to sending both the low resolution sequence of video content segments 100 and the delta-value video content segments 300. The client device can reconstruct the high resolution multi-media content from the low resolution sequence of video content segments 100 and the delta-value video content segments 300.

In various embodiments, the client device may be able to reconstruct the high resolution multi-media content from only the delta-value video content segments 300, where a previously received sequence of low resolution video content segments 100 for an earlier segment of the video content is still stored on the client device. The new delta-value video content segments 300 could be combined with older low resolution video content segment. Even lower bandwidth would be needed to communicate only the delta-value video content segment 300, so a user could receive effectively high resolution multi-media content for a short period of time without receiving the associated low resolution video content segment 100. Eventually the picture in the video frame may change sufficiently that the delta-values alone could not convey sufficient information to maintain lossless video content, and the displayed video frame would drift away from the true picture.

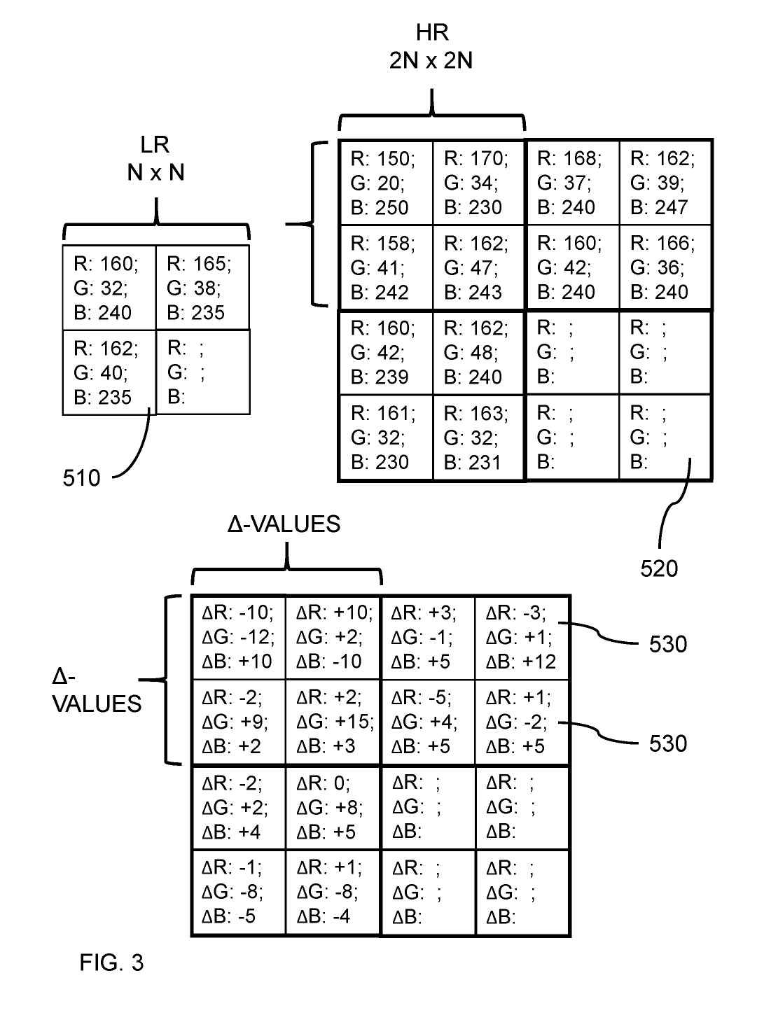

FIG. 3 is a diagram of a relationship between low resolution data (e.g., color model values), high resolution data, (e.g., color model values), and Δ-value data for a video data set using an RGB color model, in accordance with an embodiment of the present invention.

In one or more embodiments, video data may be configured as a set of values in a color model for each pixel in an N pixel by M pixel array for each frame of video data. The low resolution data 510 can be a smaller N pixel by M pixel array than the high resolution data 520. A low resolution data array can be 1/16^{th} the size of the high resolution data, where the low resolution data array can include ¼ the number of pixels in each row and column as the high resolution data array (e.g., a 4×4 HR pixel frame mapped to 1 pixel LR frame).

In one or more embodiments, the Δ-value data 530 may be the difference between a value of the low resolution data and four associated values for the high resolution data. Since the color values of adjacent pixels typically tend not to vary greatly, the difference value may be much smaller than the actual data value in the color model (e.g., RGB, YUV, Y′uv, etc.), such that the Δ-value data 530 may be stored in fewer bits than the full color value for each pixel.

In one or more embodiments, the Δ-value data 530 can be generated using a pixel mapping method that calculates differential values between high resolution data sets and low resolution data sets directly.

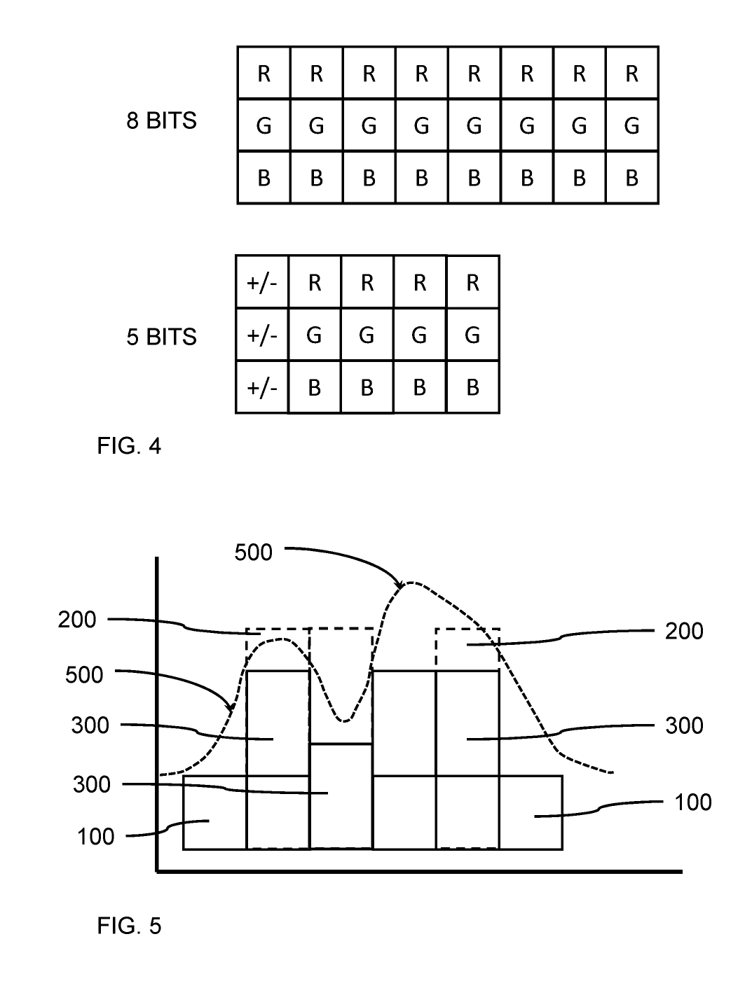

In a non-limiting exemplary embodiment, color values for four adjacent pixels can be averaged to generate a single low resolution data value 510. The Δ-value data 530 can be generated by then subtracting the RGB values for the low resolution data from each of the four sets of color values averaged to obtain the low resolution data 510 (e.g., ΔR=HR-R 150−LR-R 160=−10). As can be seen, the Δ-values are smaller than the original data values, so it can be represented by fewer bits, for example 4 bits for the value and 1 bit for the sign (positive, negative) for the change (e.g., RGB color values of 0-255 are 8-bit, whereas +16-−16 are 5 bits), as shown in FIG. 4.

In various instances, the compression of the high resolution color data may be lossy if the difference between the color model values for adjacent pixels is greater than can be saved with the fewer number of bits allocated for the Δ-values (e.g., Δ-value>±15 for signed 4 bit storage and sending).

FIG. 4 shows a representation of 8 bits used to store and send a set of color values between 0 and 255 for RGB color model data for each pixel, and the 5 bits used to store and send the Δ-values for each color of each pixel, in accordance with an embodiment of the present invention.

When the reduced number of bits for the color data is multiplied by the number of pixels in a high resolution video frame, a memory/bandwidth savings of up to about 37.5% can theoretically be obtained.

In one or more embodiments, the number of bits for the Δ-value data 530 of the color values may be increased or decreased depending on the amount of lossiness that may be acceptable for a particular multi-media article, for example, Δ-value data 530 for video content having less color value variation may be 4 bits long with 3 bits for the Δ-value and 1 sign bit, whereas Δ-value data 530 for video content having greater pixel-to-pixel color value variation may be 6 bits long with 5 bits for the Δ-value and 1 sign bit.

FIG. 5 shows a representation of available band width varying with time as a dashed line, and data packets of various size utilizing the available bandwidth, in accordance with an embodiment of the present invention.

An additional benefit of utilizing fewer bits for the color Δ-values is that the Δ-value data 530 forms smaller data packets that can be sent over a lower bandwidth communication path than what the full set of color values for all the pixels in the high resolution time segment of video content would require, so high resolution multi-media content can be received by a client device even when the communication path bandwidth would be insufficient to communicate the full color data values for the high resolution data 520.

In one or more embodiments, the multi-media content delivery system 10 can monitor the available bandwidth and provide a low resolution video content segment 100, a delta-value video content segment 300, or a combination of a low resolution video content segment 100 and a delta-value video content segment 300 over a communication path to a client device depending on the detected available bandwidth. In various embodiments, the client device (e.g., smart televisions 430, desktop personal computers 440, laptop computers 450, smart phones 460, and tablets 470) and/or computer system 410 (e.g., server) can monitor the available bandwidth to determine the amount of data that can be communicated to the client device, and whether a low resolution video content segment 100, a delta-value video content segment 300, or a combination of a low resolution video content segment 100 and a delta-value video content segment 300 should be sent to the client device.

In one or more embodiments, the determination of whether to send a low resolution video content segment 100, a delta-value video content segment 300, or a combination of a low resolution video content segment 100 and a delta-value video content segment 300 to a client device can depend on whether the detected available bandwidth meets or exceeds a predetermined threshold value. For example, a computer system 410 may send a low resolution video content segment 100 to a client device if the available bandwidth is below a first bandwidth threshold value; send a delta-value video content segment 300 to the client device if the available bandwidth is between the first bandwidth threshold value and a second bandwidth threshold value greater than the first bandwidth threshold value; and send both the low resolution video content segment 100 and a delta-value video content segment 300 if the available bandwidth is at or above the second bandwidth threshold value.

In various embodiments, the client device may be configured to add the Δ-value data 530 in a subsequently received delta-value video content segment 300 to the low resolution data values 510 of the previously received low resolution video content segment 100, where the available bandwidth 500 is between the first bandwidth threshold value and a second bandwidth threshold value. In this manner, the client device may still receive and display an equivalent high resolution video content segment when the available bandwidth 500 is not sufficient to send the combination of a low resolution video content segment 100 and a delta-value video content segment 300 to the client device. In various embodiments, different frames of video segments are not interleaved.

It should be noted that the client device can receive and display an equivalent high resolution video content segment when the available bandwidth 500 of the communication path would not be sufficient to send a high resolution video content segment 200. By computing delta values directly from what is showed to a client, the present approach is capable of switching from high quality low resolution video to high quality high resolution videos losslessly under the mechanism of DASH.

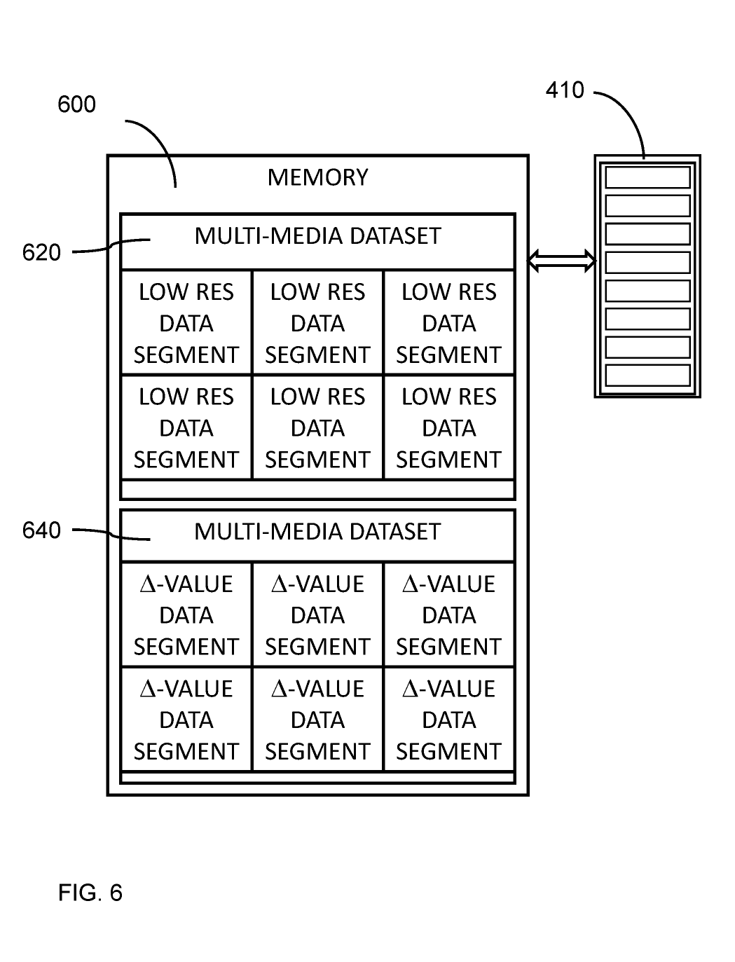

FIG. 6 is a diagram of the data segments for low resolution content segments and Δ-value data segments stored in the memory coupled to a multi-media content server (i.e., computer system), in accordance with an embodiment of the present invention.

In one or more embodiments, a system for communicating multi-media content can be coupled to memory 600 for storing one or more data segments forming a multi-media data set configured for transmission over a packet switched network. The memory may be physically included in the computer system 410 (e.g., server) or can be in a remote system connected to the computer system 410 over a communication path, for example, in the cloud or at a remote site. The cloud can include hardware and software components. Examples of hardware components include: mainframes; RISC (Reduced Instruction Set Computer) architecture based servers; servers; blade servers; storage devices; and networks and networking components. In some embodiments, software components include network application server software, web server software, and database software.

In various embodiments, a database can be implemented to organize and store one or more multi-media data sets in the memory, where the database may be suitably configured for storing multi-media articles, as would be known in the art. The memory may include optical, magnetic, and/or electronic storage, as would be known in the art.

A system or device can be considered remote if it has a different MAC address, IPv4 (Internet Protocol version 4) addresses, and/or IPv6 (Internet Protocol version 6) address that distinguishes the system or device from other systems or devices that may be located in the same or different physical locations.

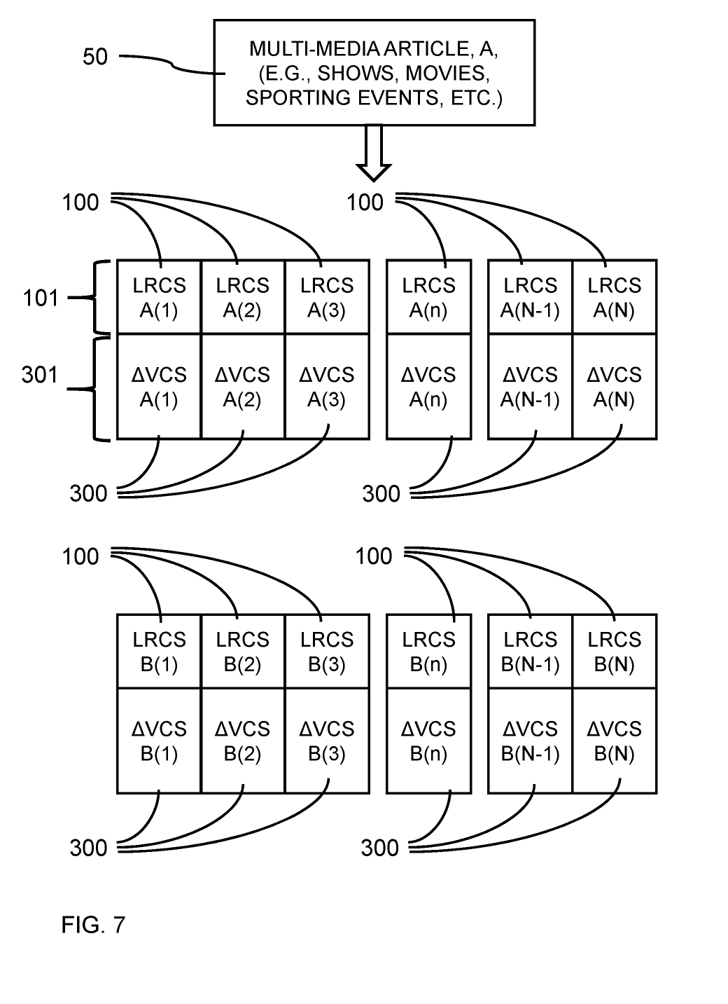

FIG. 7 is a block diagram of a sequence of low resolution and delta-value video content segments for transmission over a communication path, in accordance with an embodiment of the present invention.

In one or more embodiments, a set 101 of low resolution video content segments 100 can be prepared from a multi-media article 50, where the set of low resolution video content segments 100 can be concatenated to present the entire show, movie, concert, sporting event, MPEG file, etc. in a low resolution format. The set 101 can include a number, N, of low resolution video content segments 100. Each low resolution video content segment 100 can be a fragment of the multi-media article 50, where the fragment may have predetermined duration, for example, 3 seconds, 5 seconds, 8 seconds, etc.

In one or more embodiments, a set 301 of delta-value video content segments 300 can be prepared from a multi-media article 50, where the set of delta-value video content segments 300 can be combined with the set 101 of low resolution video content segments 100 to present the entire show, movie, concert, sporting event, MPEG file, etc. in a high resolution format. The set 301 can include a number, N, of delta-value video content segments 300. Each delta-value video content segment 300 can be a fragment of the multi-media article 50, where the fragment may have predetermined duration, for example, 3 seconds, 5 seconds, 8 seconds, etc. There can be an equal number of delta-value video content segments 300 and low resolution video content segments 100 for each multi-media article 50, where there can be a 1-to-1 correlation of delta-value video content segments 300 to low resolution video content segments 100.

In one or more embodiments, the low resolution video content segments 100 can be communicated to a client device in a predetermined order, where the low resolution video content segments 100 can be presented to a user on a client device as the low resolution video content segments 100 are received. The low resolution video content segments 100 can be communicated in order from the computer system 410 to the client device from low resolution video content segment 1 to low resolution video content segment N.

In various embodiments, a delta-value video content segment 300 can be communicated from the computer system 410 to the client device. A delta-value video content segment 300, n, may be communicated in place of a low resolution video content segment 100, n, when available bandwidth is sufficient to carry the greater amount of Δ-value data 530 in the delta-value video content segment 300 (e.g., available bandwidth is at or above the first bandwidth threshold value).

In one or more embodiments, a low resolution video content segment 100, n, and a delta-value video content segment 300, n, can be communicated sequentially when available bandwidth is sufficient to carry both video content segments (e.g., available bandwidth is at or above the second bandwidth threshold value). The client device can convert the Δ-value data 530 in the delta-value video content segment 300 and the low resolution data 510 in the low resolution video content segment 100 into a high resolution video frame for presentation on a display of the client device to a user.

In various embodiments, the computer system 410 can be configured to send a plurality of video content segments for a plurality of multi-media articles, A and B.

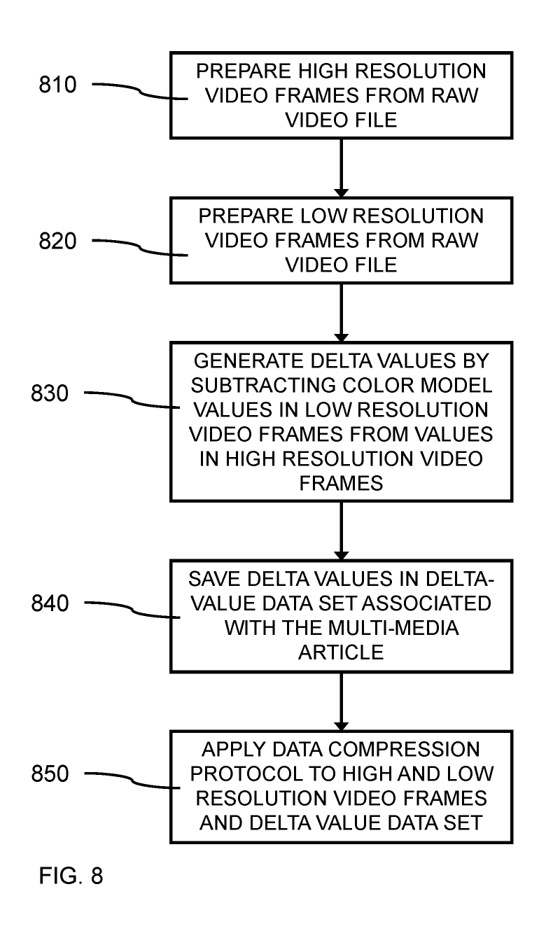

FIG. 8 is a block/flow diagram of a method to prepare video content segments from multi-media articles, in accordance with an embodiment of the invention.

In block 810, a high resolution video frame is prepared from the original multi-media article, where the original multi-media article can be in the form of a raw video file, as originally recorded or prepared (e.g., uncompressed Y′CbCr and RGB formats (4:4:4 RGB)).

The high resolution video frame can be the same pixel resolution as the raw video file (i.e., resolution is 1:1), but where each the color values for each pixel may have undergone chroma subsampling, for example, 24 bit color (4:4:4 RGB) of the raw video file may be reduced to 4:2:2 or 4:2:0.

In block 820, a low resolution video frame is prepared from the raw video file of the original multi-media article. The low resolution video frame can have a lower pixel resolution compared to the video frame of the raw video file, for example, the low resolution video frame can have a pixel ratio of 1:4 or 1:16 with the raw video file. In addition, the low resolution video frame can include chroma subsampling to reduce the number of color values, where the chroma subsampling is the same as the subsampling used for the high resolution video frame (e.g., 4:2:2, 4:2:0, etc.). A plurality of low resolution video frames can be saved as a low resolution video content segment 100. The low resolution data 510 can be saved in a low resolution video content segment 100 associated with the original multi-media article 50.

In block 830, a data set of the Δ-value data 530 can be obtained for a delta-value video frame by subtracting the color values for a pixel of the low resolution video frame from the color values of each of the corresponding pixels in the high resolution video frame to which the low resolution pixel maps. The Δ-value data 530 can be saved in a delta-value video content segment 300.

In block 840, the Δ-value data 530 for each delta-value video frame can be saved in a delta-value video content segment 300 associated with the original multi-media article 50.

In block 850, the low resolution video content segment 100 and/or delta-value video content segment 300 can be further compressed using a video compression algorithm or codec, as would be known in the art. The compressed content segments can be saved in memory.

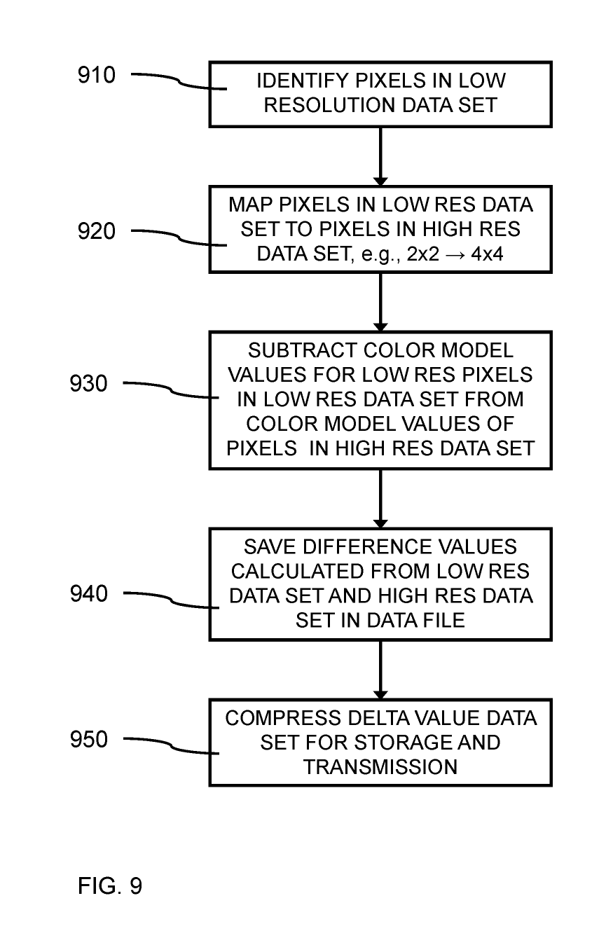

FIG. 9 is a block/flow diagram of a method for calculating Δ-values to generate delta-value video content segment(s), in accordance with an embodiment of the present invention.

In block 910, the pixels represented by a low resolution data set 510 are identified by determining the pixels in the raw video frame used to create the associated low resolution video frame.

In block 920, the pixels of the low resolution video frame can be mapped to the pixels of the high resolution video frame by identifying the associated location of the pixel in the low resolution video frame with the pixel location in the raw video frame, and determining the corresponding location of the pixel and the 3, 7, etc., neighboring pixels in the high resolution video frame, as shown in FIG. 3.

In block 930, each color value for reference pixel in the low resolution video frame is subtracted from the corresponding color value in the identified pixel and 3, 7, etc. neighboring pixels in the high resolution video frame to generate Δ-value data.

In block 940, the Δ-value data set for each frame of a delta-value video content segment can be stored in memory for later retrieval and transmission to a client device. The delta-value video content segments can be stored in a suitable format for communication over a packet-switched network, for example, HTTP.

In block 950, the delta-value video content segments can be further compressed using known compression codecs to further reduce the size of the stored data files.

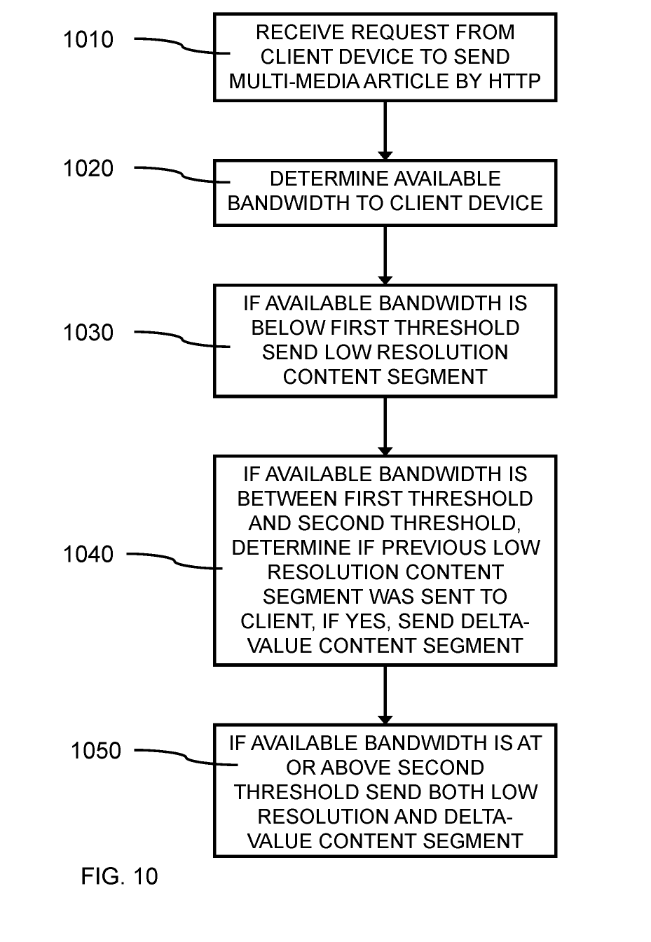

FIG. 10 is a block/flow diagram of a method for communicating video content segments for multi-media articles to client devices by DASH, in accordance with an embodiment of the present invention.

In block 1010, a computer system receives a request from a client device over a communication path, where the computer system can be configured to receive such requests at a network interface card, as would be known in the art. The request may be in the form of an HTTP request from a web browser utilizing a URL to identify a particular multi-media article (e.g., shows, movies, concerts, sporting events, MPEG file, etc.). A set 101 of low resolution video content segments 100 and a set 301 of delta-value video content segments 300 can be associated with the particular multi-media article, where the association may be implemented through a database.

In block 1020, the computer system can determine the bandwidth available over the communication path to determine if sufficient bandwidth is available to send both delta-value video content segments and low resolution video content segments, if the bandwidth is only sufficient to send only delta-value video content segments, or if the bandwidth is only sufficient to send low resolution video content segments.

In block 1030, the detected available bandwidth can be compared to a predetermined first threshold value previously determined to be sufficient for sending delta-value video content segments. If the available bandwidth is below the first threshold value, the low resolution video content segments can be sent to the requesting client device. If the available bandwidth is at or above the first threshold value, the delta-value video content segments can be sent to the requesting client device.

In block 1040, the detected available bandwidth can be compared to a predetermined second threshold value previously determined to be sufficient for sending both delta-value video content segments and low resolution video content segments, where the second threshold is greater than the first threshold. If the available bandwidth is between the first threshold value and the second threshold value, the delta-value video content segments can be sent to the requesting client device.

In block 1050, if the available bandwidth is at or above the second threshold value, both delta-value video content segments and low resolution video content segments can be sent to the requesting client device over the communication path.

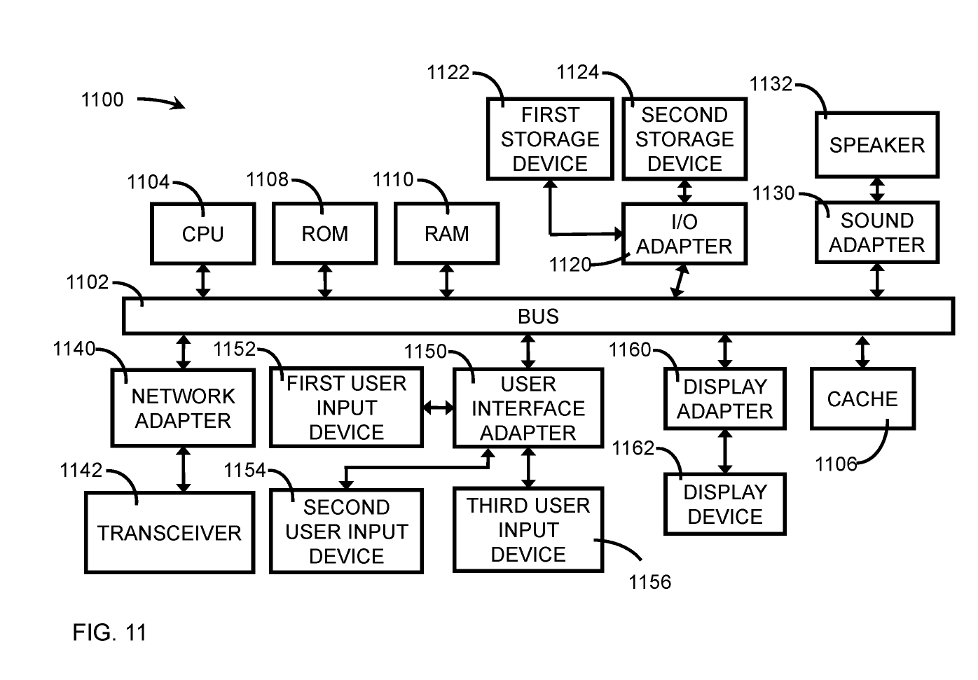

FIG. 11 is a block diagram of an exemplary processing system, which may be included in a computer system and/or client device, in accordance with an embodiment of the present invention.

In one or more embodiments, a processing system 1100 includes at least one processor (CPU) 1104 operatively coupled to other components via a system bus 1102. A cache 1106, a Read Only Memory (ROM) 1108, a Random Access Memory (RAM) 1110, an input/output (I/O) adapter 1120, a sound adapter 1130, a network adapter (e.g., network interface card (NIC)) 1140, a user interface adapter 1150, and a display adapter 1160, are operatively coupled to the system bus 1102.

A first storage device 1122 and a second storage device 1124 are operatively coupled to system bus 1102 by the I/O adapter 1020. The storage devices 1122 and 1124 can be any of a disk storage device (e.g., a magnetic or optical disk storage device), a solid state magnetic device, and so forth. The storage devices 1122 and 1124 can be the same type of storage device or different types of storage devices.

A speaker 1132 is operatively coupled to system bus 1102 by the sound adapter 130. A transceiver 1142 is operatively coupled to system bus 1102 by network adapter 1040. A display device 1162 is operatively coupled to system bus 1102 by display adapter 1160.

A first user input device 1152, a second user input device 1154, and a third user input device 1156 are operatively coupled to system bus 1102 by user interface adapter 1050. The user input devices 1152, 1154, and 1156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 1152, 1154, and 1156 can be the same type of user input device or different types of user input devices. The user input devices 1152, 1154, and 1156 are used to input and output information to and from system 1100.

Of course, the processing system 1100 may also include other elements (not shown), as readily contemplated by one of skill in the art, as well as omit certain elements. For example, various other input devices and/or output devices can be included in processing system 1100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 1100 are readily contemplated by one of ordinary skill in the art given the teachings of the present principles provided herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method of providing high resolution video content with reduced latency, comprising:
determining available bandwidth of a communication path; and
sending delta-value video content segments to a client device if the available bandwidth is above a first threshold value.

2. The method of claim 1, further comprising sending low resolution video content segments to the client device if the available bandwidth is below the first threshold value.

3. The method of claim 2, wherein the low resolution video content segments or delta-value video content segments are sent in response to a Hypertext Transfer Protocol (HTTP) requests.

4. The method of claim 2, further comprising reconstructing high resolution multi-media content from the low resolution video content segments and the delta-value video content segments.

5. The method of claim 1, further comprising generating delta-value video content segments by subtracting color model values for each low resolution video frame of a low resolution video content segment from the color model values of an associated high resolution video frame of the high resolution video content segment.

6. The method of claim 5, wherein each of the delta-value video content segments has fewer bits than the high resolution video content segment from which the delta-value video content segment was generated.

7. The method of claim 5, wherein the color model values are in an RGB color value format or an LUV color model format.

8. The method of claim 5, further comprising saving the generated delta-value video content segments in a memory coupled to a computer system configured to receive a Hypertext Transfer Protocol (HTTP) request.

9. The method of claim 1, further comprising sending both low resolution video content segments and the delta-value video content segments if the available band width is above a second threshold, where the second threshold is greater than the first threshold.

10. A method of providing high resolution video content to a client device with reduced latency, comprising:
generating delta-value video content segments from low resolution video content segments and high resolution video content segments;
receiving a Hypertext Transfer Protocol (HTTP) request for a multi-media article from a client device;
determining available bandwidth of a communication path to the client device;
sending low resolution video content segments to the client device if the available bandwidth is below a first threshold value, and sending delta-value video content segments to a client device if the available bandwidth is above the first threshold value.

11. The method of claim 10, further comprising sending both the low resolution video content segments and the delta-value video content segments if the available band width is above a second threshold, where the second threshold is greater than the first threshold.

12. The method of claim 10, wherein the delta-value video content segments include the difference between the pixel color values of the low resolution video content segments and the high resolution video content segments.

13. The method of claim 10, further comprising compressing the delta-value video content segments and low resolution video content segments using a video compression algorithm/codec, and storing the compressed delta-value video content segments and low resolution video content segments in memory.

14. The method of claim 10, further comprising utilizing chroma subsampling to reduce the size of the low resolution video content segments.

15. The method of claim 10, wherein the client device is a smart television, desktop personal computer, laptop computer, smart phone, or tablet.

16. A multi-media content delivery system, comprising:
a computer system coupled to a memory and having a network interface, wherein the computer system is configured to store one or more low resolution video content segments and one or more delta-value video content segments in the memory, and wherein the computer system is further configured to determine the available bandwidth to a client device of a communication path coupled to the network interface, and send at least one of the one or more delta-value video content segments to the client device in response to a Hypertext Transfer Protocol (HTTP) request.

17. The system of claim 16, wherein the one or more low resolution video content segments and one or more delta-value video content segments are stored in a compressed format.

18. The system of claim 16, wherein the computer system is further configured to determine if the available bandwidth is above or below a first threshold.

19. The system of claim 16, wherein the memory is in the cloud or at a remote site.

20. The system of claim 16, wherein the computer system is further configured to send one or more delta-value video content segments as packets in response to a GET request or partial GET request.
